(19) United States
(12) Patent Application Publication
(10) Pub. No.: US 2013/0316145 A1
(43) Pub. Date: Nov. 28, 2013

(54) PROCESS FOR LAYER-BY-LAYER PRODUCTION OF THREE-DIMENTIONAL OBJECTS

(71) Applicants: Wolfgang Diekmann, Waltrop (DE); Maik Grebe, Bochum (DE)

(72) Inventors: Wolfgang Diekmann, Waltrop (DE); Maik Grebe, Bochum (DE)

(21) Appl. No.: 13/889,568

(22) Filed: May 8, 2013

(30) Foreign Application Priority Data
May 8, 2012 (DE) 10 2012 207 609.3

(51) Int. Cl. B29C 67/00

(52) U.S. Cl. CPC B29C 67/0077
USPC 428/172; 264/497; 425/141

(57) ABSTRACT

The present invention provides processes for the layer-by-layer production of three-dimensional objects using a powder material comprising polyamide PA613 and also to the moldings obtained according to the process.

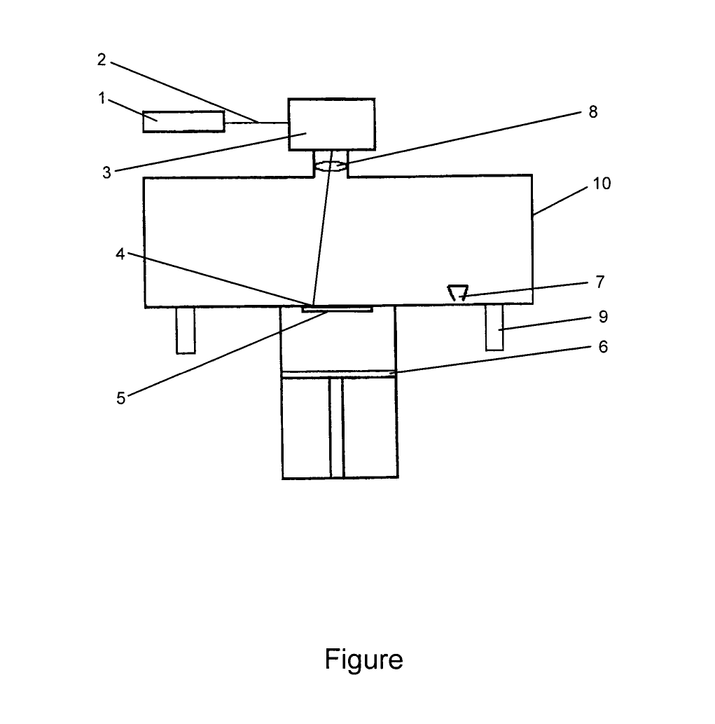

### CROSS REFERENCE TO RELATED APPLICATIONS

This application claims priority to German Application No. 102012207609.3, filed May 8, 2012, the disclosure of which is incorporated herein by reference in its entirety.

### BACKGROUND OF THE INVENTION

The present invention relates to a process for the layer-by-layer production of three-dimensional objects employing a molding powder composition containing polyamide 613(PA613) as a molding material and the PA613 moldings.

The rapid provision of prototypes is frequently required in the development and construction of molded objects. Processes which achieve such prototype construction are termed rapid prototyping/rapid manufacturing or else additive fabrication processes. Particularly suitable processes are those which operate on the basis of materials in powder form, where the desired structures are produced layer-by-layer, by selective melting and solidifying. Supportive constructions for overhangs and undercuts are not needed in the layer-by-layer method, since the plane of the construction field that surrounds the melted regions provides sufficient support. The subsequent operation of removing supports is eliminated in this method. The processes are also suitable for producing short runs. The temperature of the construction chamber is selected such that there is no warpage of the layerwise-produced structures during the construction procedure.

One process, which is especially suitable for the purpose of rapid prototyping is that of selective laser sintering (SLS). In this process, plastics powders in a chamber are exposed briefly and selectively to a laser beam, causing melting of the powder particles struck by the laser beam. The melted particles coalesce and re-solidify rapidly to form a solid mass. By repeated exposure of a constant succession of freshly applied layers, this process can be used for rapid and simple production of three-dimensional bodies.

The process of laser sintering (rapid prototyping) for the purpose of producing mouldings from polymers in powder form is described comprehensively in U.S. Pat. No. 6,136,948 and WO 96/06881 to DTM Corporation. A multiplicity of polymers and copolymers is claimed for this application, including polymers such as polyacetate, polypropylene, polyethylene, ionomers and polyamides, for example.

Other highly suitable processes are described in WO 01/38061, in EP 1015214, DE 10311438 or WO 2005/105412.

Polyamides in powder form such as polyamide 12 (PA12) or polyamide 11 (PA11) are conventionally used for rapid prototyping. A problem of the conventional processes described above is that the mechanical characteristics of the components produced (moldings) are unsatisfactory. Materials which can be processed by laser sintering have either a high modulus of elasticity and a low elongation at break, or a high elongation at break and a low modulus of elasticity. For numerous applications a combination of high modulus of elasticity and high elongation at break would be desirable.

It is an object of the present invention, therefore, to provide a process for the layer-by-layer production of three-dimensional objects which have a high modulus of elasticity, a high elongation at break, and a high tensile strength.

### SUMMARY OF THE INVENTION

This and other objects have been achieved by the present invention, the first embodiment of which includes a process for layer-by-layer production of a three-dimensional object, the process comprising:

applying a layer of a powder material comprising polyamide PA613 onto a vertically moveable construction platform in a construction chamber to obtain a planar layer;

focusing a beam of electromagnetic radiation through a lens on a plane of the powder material layer;

traversing the focused beam across the plane of the powder material layer as directed by a control unit;

selectively melting the powder material under the focus of the beam according to the control unit to obtain a layer having a completed melt pattern;

lowering the vertically moveable construction platform; and

adding a layer of the powder material onto the layer having a completed melt pattern;

repeating the controlled melting; and

continuously adding a further layer of the powder material over the previous completed layer and repeating the controlled melting until the melt pattern of the three dimensional object is formed;

cooling the melt pattern to harden to the three dimensional shape; and

removing the three dimensional object from adhering powder material not melted by the focused beam to obtain the three dimensional molded object.

In a second embodiment, the present invention also includes three dimensional molded objects having polyamide PA613 as a material of construction.

### BRIEF DESCRIPTION OF THE DRAWING

The FIGURE shows a schematic diagram of an apparatus for layer-by-layer production of moldings according to an embodiment of the invention.

### DETAILED DESCRIPTION OF THE INVENTION

Surprisingly it has been found that polyamide 613 (PA613) when used as the powder in the process for the layer-by-layer production of three-dimensional objects provides three-dimensional objects which have a high modulus of elasticity, a high elongation at break, and a high tensile strength. As well as the higher modulus of elasticity of a PA613, as known from injection molded components, laser sintering is accompanied by an increase in the elongation at break and in the tensile strength of the components produced, contrary to the characteristic values known for this polyamide from injection molding. The achievement of the improved physical properties of moldings with polyamide PA613 is especially surprising given that the polyamides PA11 and PA12, typically used for rapid prototyping, do not satisfy these requirements.

The present invention accordingly provides a process for the layer-by-layer production of three dimensional objects, using a powder material comprising a polyamide PA613. Especially preferred are processes for the layer-by-layer production of three-dimensional objects which are conducted in an apparatus as shown in the FIGURE comprising a construction chamber (10) having an adjustable-height construction platform (6), an apparatus (7) for applying the polyamide (a layer of a PA613 powder solidifiable by exposure to electromagnetic radiation) to the construction platform (6 ), an irradiation device comprising a radiation source (1) which emits electromagnetic radiation, a control unit (3) and a lens (8) which is located in the beam path of the electromagnetic radiation. The lens (8) is suitable for irradiating layer locations corresponding to the object (5).

According to the first embodiment of the invention the process comprises: applying a layer of a powder material comprising polyamide PA613 onto a vertically moveable construction platform in a construction chamber to obtain a planar layer;

focusing a beam of electromagnetic radiation through a lens on a plane of the material layer;

traversing the focused beam across the plane of the material layer as directed by a control unit;

selectively melting the powder material under the focus of the beam according to the control unit to obtain a layer having a completed melt pattern;

lowering the vertically moveable construction platform; and

adding a layer of the powder material onto the layer having a completed melt pattern;

repeating the controlled melting; and

continuously adding a further layer of the powder material over the previous completed layer and repeating the controlled melting until the melt pattern of the three dimensional object is formed;

cooling the melt pattern to harden to the three dimensional shape; and

removing the three dimensional object from adhering powder material not melted by the focused beam.

Polyamide 613, in accordance with ISO 1874-1 nomenclature, is an AABB-type aliphatic polyamide. It may be obtained by condensation of hexamethylenediamine and brassylic acid. Diamine and dicarboxylic acid may be used in equimolar amounts; it is also possible, however to use either the diamine or the dicarboxylic acid in excess.

Suitable polyamides of the present invention may have a number-average molecular weight of 8000 to 50 000 g/mol, as measured by gel permeation chromatography against styrene standard.

A preferred PA613 powder may have independently of one another, at least one of the following mechanical properties, preferably all, the respective test parameters being reported in Tables 3 to 5.

Bulk density: 0.35 to 0.55 g/cm³

Particle size (d50): 30 to 80 μm, preferably 40 to 75 μm

Pourability: not more than 70 s, preferably 20 to 30 s

Solution viscosity: 1.5 to 2.2, preferably 1.55 to 2

BET: 0.01 to 30 m²/g, preferably 0.1 to 20 m²/g, more preferably 0.5 to 20 m²/g and very preferably 0.75 to 10 m²/g

Melting point (1st heating procedure): 205 to 215° C., preferably 207 to 213° C.

Recrystallization temperature: 150 to 200° C., preferably 155 to 190° C., more preferably 158 to 180° C.

The powder material may comprise at least 47 wt % of polyamide 613. The PA613 content is preferably at least 75 wt %, more preferably at least 85 wt %, very preferably at least 90 wt %, especially preferably at least 95 wt % and more particularly at least 97 wt % of the powder material, based in each case on the total weight of the powder material.

The powder material may comprise fillers such as glass beads. The fillers may be present in a fraction of up to 50 wt %, based on the total weight of the powder material.

The powder material may also contain up to 3 wt % of auxiliaries, based on the total weight of the powder material. Such auxiliaries and their fractions are conventionally known, and include, for example, pourability aids (preferred fraction: not more than 0.6 wt %), catalysts (preferred fraction: not more than 1 wt %) and stabilizers (preferred fraction: not more than 1 wt %; based in each case on the total weight of the powder material).

There may, furthermore, be other polymers present in the powder material, more particularly other polyamides. Their fraction is preferably less than 10 wt %, more preferably less than 5 wt % and very preferably less than 2 wt %. With very particular preference there is no other polymer present in the powder material apart from PA613.

The invention further provides for the use of the above-defined powder material comprising PA613 for the layer-by-layer production of three-dimensional objects.

Additionally provided by the invention are moldings obtained by the process of the invention. The modulus of elasticity of the moldings is preferably at least 2000 MPa, more preferably at least 2200 MPa. Furthermore, the moldings preferably have an elongation at break of at least 30%. The tensile strength moreover, is preferably at least 50 MPa, more preferably at least 54 MPa. In one particularly preferred embodiment of the invention, the moldings have a modulus of elasticity of at least 2000 MPa, very preferably at least 2200 MPa, an elongation at break of at least 30% and a tensile strength of at least 50 MPa, very preferably at least 54 MPa. The measurements are made on moldings which have been stored for 24 hours under a pressure of 1013 hPa, a temperature of 20° C. and a relative humidity of 50%.

For suitability as powder material in processes for the layer-by-layer production of three-dimensional objects, the lower limits specified above are preferably to be observed. The upper limits with regard to the properties of the moldings may dependent in particular on the technical properties sought in the molding. Fillers may be added to the powder composition to adjust these properties.

Powder material comprising at least 97 wt % of polyamide 613 may attain upper limits of 2500 MPa (modulus of elasticity) and 65 MPa (tensile strength). Depending on the type and proportion of filler, moduli of elasticity of up to 4000 MPa may be obtained.

The mechanical characteristics of these moldings (modulus of elasticity, elongation at break and tensile strength) are determined in accordance with DIN EN ISO 527. Specified therefore are a testing rate of 50 mm/min, a modulus of elasticity testing rate of 1 mm/min, a clamped length at starting position of 115 mm, a measurement length of 50 mm as standard travel, the beginning of determination of modulus of elasticity at 0.05% and the end of determination of modulus of elasticity at 0.25%. The measurements are made on a tensile tester from Zwick Roell, Germany, with parallel clamping jaws.

In operation of the process, data concerning the shape of the object (molding 5) to be produced is generally first generated or stored in a computer, on the basis of a construction program or the like. This data, for production of the object, is processed in such a way that the object is dissected into a multiplicity of horizontal layers, thin in comparison with the size of the object, and the shape data is provided in the form, for example, of data sets, such as CAD data, for example, for each of this multiplicity of layers. The generation and processing of the data for each layer may take place before the production or else simultaneously with the production of each layer.

The construction platform (6) is then first moved by the height adjustment apparatus to the highest position in which the surface of the construction platform (6) is in the same plane as the surface of the construction chamber, then lowered by an amount corresponding to the intended thickness of the first layer of material, in such a way that, within the resultant aperture, a lowered region is formed, delimited laterally by the walls of the aperture and below the surface of the construction platform (6). A first layer of the material to be solidified, with the intended layer thickness, is then introduced by means of the application apparatus (7) into the cavity formed by the aperture and the construction platform (6), or into the lowered region, and is optionally heated by a heating system to a suitable operating temperature. For powder materials of PA613, a processing temperature of at least 190° C. may be advantageous in terms of the warping tendency and the mechanical characteristics of the components. The control unit (3) thereafter controls the deflector device in such a way that the deflected light beam (2) successively strikes all locations of the layer and sinters or melts the material there. In this way it is possible first of all to form a solid basal layer. In a second step, the construction platform (6) is lowered the height adjustment apparatus by an amount corresponding to one layer thickness, and a second layer of material is introduced by the application apparatus (7) into the resultant lowered region within the aperture, and optionally is in turn heated by the heating system.

In one embodiment, the deflector device is controlled by the control unit (3) in such a way that the deflected light beam (2) impinges only on the region of the layer of material adjacent to the inner surface of the aperture, and solidifies the layer of material there by sintering thus producing a first annular wall layer with a wall thickness of about 2 to 10 mm, which completely surrounds the remaining powder material of the layer. This part of the control system therefore constitutes a means for generating a container wall surrounding the object (5) to be formed, simultaneously with the formation of the object in each layer.

After the construction platform (6) has been lowered by the amount of the thickness of the next layer, and material has been applied and heated in the same way as above, the production of the object (5) itself can then begin. For this purpose, the control unit (3) controls the deflector device in such a way that the deflected light beam (2) strikes those locations in the layer which are to be solidified in accordance with the coordinates stored in the control unit for the object (5) to be produced. The procedure for the other layers is analogous. In the case of the desired production of an annular wall region in the form of a container wall, which surrounds the object together with the remaining, unsintered material and so prevents escape of the material when the construction platform (6) is lowered below the worktable, the device is used to sinter an annular wall layer onto the underlying annular wall layer for each layer of the object. Production of the wall can be omitted if a replaceable vessel in accordance with EP 1037739 or a fixedly installed container is used.

After cooling, the object formed may be removed from the apparatus.

The three-dimensional objects or components produced with the processes of the invention are likewise provided by the present invention.

It is assumed, even without further observations, that a skilled person is able to utilize the above description in its widest scope. The preferred embodiments and examples are therefore to be interpreted merely as descriptive material which in no way represents a disclosure with any limiting effect whatsoever. Having generally described this invention, a further understanding can be obtained by reference to certain specific examples which are provided herein for purposes of illustration only, and are not intended to be limiting unless otherwise specified.

### EXAMPLES

The examples were operated in accordance with the description below, unless otherwise indicated. The construction compartment was preheated for 180 minutes to a temperature which is 20° C. below the processing temperature. Thereafter the temperature in the construction compartment was raised to the processing temperature. The temperature distribution within the construction chamber was not always homogeneous, and therefore the temperature measured by means of a pyrometer was defined as construction chamber/processing temperature. Prior to the first exposure, 40 layers of powder were applied. From a laser (1), the laser beam (2) was guided by means of a scanning system (3) through the lens (8) onto the heated and inertized (N₂) plane (4) of the construction field. The atmosphere of the construction chamber ought to have an oxygen content of less than 3 volume %, preferably less than 2 volume % and more preferably of less than 1 volume %.

The components to be exposed were positioned centrally in the construction field. Six areas in the form of tensile test specimens in accordance with DIN EN ISO 527 type 1B were melted by means of the laser beam. The energy input was between 20 and 80 mJ/mm². Thereafter the construction platform (6) was lowered by one layer thickness and an application apparatus applied a new powder layer at a rate of 100 mm/s. These steps were repeated until 6 objects with a height of 4 mm were produced. After the end of the exposure operation a further 40 layers were applied before the heating elements were shut off and the cooling phase initiated. The time required for each layer during the entire construction process was less than 40 seconds.

After a cooling time of at least 12 hours the component was removed and freed from the adhering powder. The mechanical characteristics of these components were determined in accordance with DIN EN ISO 527 on a Zwick Z020 (testing rate 50 mm/min, modulus of elasticity testing rate 1 mm/min, clamped length at starting position 115 mm, measurement length standard travel 50 mm, start of elasticity modulus determination 0.05%, end of elasticity modulus determination 0.25%).

Table 6 lists the results of the examples. With the conventional powder materials PA11 and PA12 it was not possible, even when varying the processing parameters, to produce components which were able to evidence a high strength and a high modulus of elasticity and which at the same time also have a high elongation at break. With a PA613 powder, by contrast, it was possible for a multiplicity of processing parameter variations, to produce components which have a high modulus of elasticity and a high strength and at the same time a high elongation at break.

### Example 1

### Not According to the Invention

The construction process was carried out on an EOSINT P360 from EOS GmbH. The powder processed was a PA12 powder having the powder characteristics from Table 1. The powder was applied by the coating apparatus of the EOSINT P360. The layer thickness was 0.15 mm. The processing temperature was 168° C. The exposure parameters were as follows: laser power 19.0 W, scan velocity 1100 mm/s, distance between exposure lines 0.3 mm.

### Example 2

### Not According to the Invention

The construction process was carried out on an EOSINT P380 from EOS GmbH. The powder processed was a PA12 powder having the powder characteristics from Table 1. The powder was applied by the coating apparatus of the EOSINT P380. The layer thickness was 0.15 mm. The processing temperature was 174° C. The exposure parameters were as follows: laser power 36.0 W, scan velocity 2000 mm/s, distance between exposure lines 0.3 mm.

### Example 3

### Not According to the Invention

The construction process was carried out on an EOSINT P395 from EOS GmbH. The powder processed was a PA12 powder having the powder characteristics from Table 1. The powder was applied by the coating apparatus of the EOSINT P395. The layer thickness was 0.12 mm. The processing temperature was 173° C. The exposure parameters were as follows: laser power 42.0 W, scan velocity 4000 mm/s, distance between exposure lines 0.3 mm.

### Example 4

### Not According to the Invention

The construction process was carried out on an EOSINT P395 from EOS GmbH. The powder processed was a PA12 powder having the powder characteristics from Table 1. The powder was applied by a conventional coating apparatus of the EOSINT P395. The layer thickness was 0.12 mm. The processing temperature was 173° C. The exposure parameters utilized were the Part Property Profiles EOS PA2200 Balance.

### Example 5

### Not According to the Invention

The construction process was carried out on an EOSINT P395 from EOS GmbH. The powder processed was a PA12 powder having the powder characteristics from Table 1. The powder was applied by a conventional coating apparatus of the EOSINT P395. The layer thickness was 0.10 mm. The processing temperature was 173° C. The exposure parameters utilized are the Part Property Profiles EOS PA2200 Performance.

### Example 6

### Not According to the Invention

The construction process was carried out on a SPro60 HDHS from 3d-systems. The powder processed was a PA12 powder having the powder characteristics from Table 1. The powder was applied by the coating apparatus of the SPro60 HDHS. The processing temperature was 167° C. The temperature in the powder reservoir was 128° C. in each case. The exposure parameters were as follows: laser power 54.0 W, scan velocity 12 000 mm/s, distance between exposure lines 0.3 mm.

### Example 7

### Not According to the Invention

The construction process was carried out on an EOSINT P380 from EOS GmbH. The powder processed was a PA11 powder having the powder characteristics from Table 2. The powder was applied by the coating apparatus of the EOSINT P380. The layer thickness was 0.15 mm. The processing temperature was 183° C. The exposure parameters were as follows: laser power 36.0 W, scan velocity 2000 mm/s, distance between exposure lines 0.3 mm.

### Example 8

### Not According to the Invention

The construction process was carried out on an EOSINT P380 from EOS GmbH. The powder processed was a PAH powder having the powder characteristics from Table 2. The powder was applied by the coating apparatus of the EOSINT P380. The layer thickness was 0.12 mm. The processing temperature was 184° C. The exposure parameters were as follows: laser power 19.0 W, scan velocity 1100 mm/s, distance between exposure lines 0.3 mm.

### Example 9

### According to the Invention

The construction process was carried out on an EOSINT P360 from EOS GmbH. The powder processed was a PA613 powder having the powder characteristics from Table 3. The powder was applied by the coating apparatus of the EOSINT P360. The layer thickness was 0.15 mm. The processing temperature was 199° C. The exposure parameters were as follows: laser power 18.0 W, scan velocity 1000 mm/s, distance between exposure lines 0.3 mm.

### Example 10

### According to the Invention

The construction process was carried out on an EOSINT P380 from EOS GmbH. The powder processed was a PA613 powder having the powder characteristics from Table 3. The powder was applied by the coating apparatus of the EOSINT P380. The layer thickness was 0.15 mm. The processing temperature was 196° C. The exposure parameters were as follows: laser power 36.0 W, scan velocity 2000 mm/s, distance between exposure lines 0.3 mm.

### Example 11

### According to the Invention

The construction process was carried out on an EOS1NT P395 from E08 GmbH. The powder processed was a PA613 powder having the powder characteristics from Table 3. The powder was applied by the coating apparatus of the EOSINT P395. The layer thickness was 0.12 mm. The processing temperature was 198° C. The exposure parameters were as follows: laser power 24.0 W, scan velocity 2000 mm/s, distance between exposure lines 113 mm.

### Example 12

### Aaccording to the Invention

The construction process was carried out on an EOSINT P395 from EOS GmbH. The powder processed was a PA613 powder having the powder characteristics from Table 3. The powder was applied by the coating apparatus of the EOSINT P395. The layer thickness was 0.12 mm. The processing temperature was 198° C. The exposure parameters were as follows: laser power 32.0 W, scan velocity 4000 mm/s, distance between exposure lines 0.2 mm.

### Example 13

### According to the Invention

The construction process was carried out on an EOSINT P395 from EOS GmbH. The powder processed was a PA613 powder having the powder characteristics from Table 4. The powder was applied by the coating apparatus of the EOSINT P395. The layer thickness was 0.12 mm. The processing temperature was 198° C. The exposure parameters were as follows: laser power 36.0 W, scan velocity 4000 mm/s, distance between exposure lines 0.3 mm.

### Example 14

### According to the Invention

The construction process was carried out on an EOSINT P395 from EOS GmbH. The powder processed was a PA613 powder having the powder characteristics from Table 4. The powder was applied by the coating apparatus of the EOSINT P395. The layer thickness was 0.10 mm. The processing temperature was 198° C. The exposure parameters were as follows: laser power 32.0 W, scan velocity 4000 mm/s, distance between exposure lines 0.3 mm.

### Example 15

### According to the Invention

The construction process was carried out on an EOSINT P395 from EOS GmbH. The powder processed was a PA613 powder having the powder characteristics from Table 4. The powder was applied by the coating apparatus of the EOSINT P395. The layer thickness was 0.12 mm. The processing temperature was 198° C. The exposure parameters were as follows: laser power 36.0 W, scan velocity 4000 mm/s, distance between exposure lines 0.3 mm.

### Example 16

### According to the Invention

The construction process was carried out on an EOSINT P395 from EOS GmbH. The powder 30 processed was a PA613 powder having the powder characteristics from Table 5. The powder was applied by the coating apparatus of the EOSINT P395. The layer thickness was 0.12 mm. The processing temperature was 198° C. The exposure parameters were as follows: laser power 36.0 W, scan velocity 4000 mm/s, distance between exposure lines 0.3 mm.

### Example 17

### According to the Invention

The construction process was carried out on a SPro60 HDHS from 3d-systems. The powder processed was a PA613 powder having the powder characteristics from Table 5. The powder was applied by the coating apparatus of the SPro60 HDHS. The processing temperature was 196° C. The temperature in the powder reservoir was 135° C. in each case. The exposure parameters were as follows: laser power 54.0 W, scan velocity 12 000 mm/s, distance between exposure lines 0.3 mm.

TABLE 1
Characteristics of PA12 powder

| | Value | Unit | Test type/Test equipment/Test parameters |
|---|---|---|---|
| Polymer | Polyamide | | |
| | 12 | | |
| Bulk density | 0.452 | g/cm³ | DIN EN ISO 60 |
| Particle size d50 | 56 | μm | Malvern Mastersizer 2000, dry |
| | | | measurement, 20-40 g of powder added |
| | | | using Scirocco dry dispersion equipment. |
| | | | Feed rate vibratory trough 70%, dispersion |
| | | | air pressure 3 bar. Sample measurement |
| | | | time 5 seconds (5000 individual |
| | | | measurements), refractive index and blue- |
| | | | light value defined as 1.52. Evaluation via |
| | | | Mie theory |
| Particle size d10 | 32 | μm | Malvern Mastersizer 2000, for parameters |
| | | | see particle size d50 |
| Particle size d90 | 82 | μm | Malvern Mastersizer 2000, for parameters |
| | | | see particle size d50 |
| Mass fraction of | 3 | % | Malvern Mastersizer 2000, for parameters |
| particle size <10.48 μm | | | see particle size d50 |
| Pourability | 24 | s | DIN EN ISO 6186, method A, nozzle outlet |
| | | | diameter 15 mm |
| Solution viscosity | 1.59 | — | ISO 307, Schott AVS Pro, solvent acidic m- |
| | | | cresol, volumetric method, duplicate |
| | | | determination, dissolution temperature |
| | | | 100° C., dissolution time 2 h, polymer |
| | | | concentration 5 g/l, measurement |
| | | | temperature 25° C. |
| BET (spec. surface | 5.2 | m²/g | ISO 9277, Micromeritics TriStar 3000, gas |
| area) | | | adsorption of nitrogen, discontinuous |
| | | | volumetric method, 7 measurement points |
| | | | at relative pressures P/P0 between about |
| | | | 0.05 and about 0.20, dead volume |
| | | | calibration by means of He(99.996%), |
| | | | sample preparation 1 h at 23° C. + 16 h at |
| | | | 60° C. under vacuum, specific surface area |
| | | | based on devolatilized sample, evaluation |
| | | | by multi-point determination |
| Melting point 1^{st} | 187 | ° C. | DIN 53765 DSC 7 from Perkin Elmer |
| heating procedure | | | heating./cooling rate 20 K/min |
| Recrystallization | 139 | ° C. | DIN 53765 DSC 7 from Perkin Elmer |
| temperature | | | heating./cooling rate 20 K/min |

| | |
|---|---|
| Conditioning of the | Material is stored for 24 h at 23° C. and 50% humidity before |
| material | processing/analysis |

TABLE 2
Characteristics of PA11 powder

| | Value | Unit | Test type/Test equipment/Test parameters |
|---|---|---|---|
| Polymer | Polyamide | | |
| | 11 | | |
| Bulk density | 0.48 | g/cm³ | DIN EN ISO 60 |
| Particle size d50 | 47 | μm | Malvern Mastersizer 2000, dry |
| | | | measurement, 20-40 g of powder added |
| | | | using Scirocco dry dispersion equipment. |
| | | | Feed rate vibratory trough 70%, dispersion |
| | | | air pressure 3 bar. Sample measurement |
| | | | time 5 seconds (5000 individual |
| | | | measurements), refractive index and blue- |
| | | | light value defined as 1.52. Evaluation via |
| | | | Mie theory |
| Particle size d10 | 19 | μm | Malvern Mastersizer 2000, for parameters |
| | | | see particle size d50 |
| Particle size d90 | 77 | μm | Malvern Mastersizer 2000, for parameters |
| | | | see particle size d50 |
| Mass fraction of | 5 | % | Malvern Mastersizer 2000, for parameters |
| particle size <10.48 μm | | | see particle size d50 |
| Pourability | 32 | s | DIN EN ISO 6186, method A, nozzle outlet |
| | | | diameter 15 mm |
| Solution viscosity | 1.85 | — | ISO 307, Schott AVS Pro, solvent sulphuric |
| | | | acid, volumetric method, duplicate |
| | | | determination, dissolution temperature |
| | | | 100° C., dissolution time 2 h, polymer |
| | | | concentration 5 g/l, measurement |
| | | | temperature 25° C. |
| BET (spec. surface | 0.7 | m²/g | ISO 9277, Micromeritics TriStar 3000, gas |
| area) | | | adsorption of nitrogen, discontinuous |
| | | | volumetric method, 7 measurement points |
| | | | at relative pressures P/P0 between about |
| | | | 0.05 and about 0.20, dead volume |
| | | | calibration by means of He(99.996%), |
| | | | sample preparation 1 h at 23° C. + 16 h at |
| | | | 80° C. under vacuum, specific surface area |
| | | | based on devolatilized sample, evaluation |
| | | | by multi-point determination |
| Melting point 1st | 205 | ° C. | DIN 53765 DSC 7 from Perkin Elmer |
| heating procedure | | | heating./cooling rate 20 K/min |
| Recrystallization | 149 | ° C. | DIN 53765 DSC 7 from Perkin Elmer |
| temperature | | | heating./cooling rate 20 K/min |

| | |
|---|---|
| Conditioning of the | Material is stored for 24 h at 23° C. and 50% humidity before |
| material | processing/analysis |

TABLE 3
Characteristics of PA613 powder

| | Value | Unit | Test type/Test equipment/Test parameters |
|---|---|---|---|
| Polymer | PA613 | | |
| Bulk density | 0.470 | g/cm³ | DIN EN ISO 60 |
| Particle size d50 | 70 | μm | Malvern Mastersizer 2000, dry |
| | | | measurement, 20-40 g of powder added |
| | | | using Scirocco dry dispersion equipment. |
| | | | Feed rate vibratory trough 70%, dispersion |
| | | | air pressure 3 bar. Sample measurement |
| | | | time 5 seconds (5000 individual |
| | | | measurements), refractive index and blue- |
| | | | light value defined as 1.52. Evaluation via |
| | | | Mie theory |
| Particle size d10 | 30 | μm | Malvern Mastersizer 2000, for parameters |
| | | | see particle size d50 |
| Particle size d90 | 97 | μm | Malvern Mastersizer 2000, for parameters |
| | | | see particle size d50 |
| Mass fraction of | 6 | % | Malvern Mastersizer 2000, for parameters |
| particle size <10.48 μm | | | see particle size d50 |
| Pourability | 60 | s | DIN EN ISO 6186, method A, nozzle outlet |
| | | | diameter 15 mm |
| Solution viscosity | 1.73 | — | ISO 307, Schott AVS Pro, solvent sulphuric |
| | | | acid, volumetric method, duplicate |
| | | | determination, dissolution temperature |
| | | | 100° C., dissolution time 2 h, polymer |
| | | | concentration 5 g/l, measurement |
| | | | temperature 25° C. |
| BET (spec. surface | 6.7 | m²/g | ISO 9277, Micromeritics TriStar 3000, gas |
| area) | | | adsorption of nitrogen, discontinuous |
| | | | volumetric method, 7 measurement points |
| | | | at relative pressures P/P0 between about |
| | | | 0.05 and about 0.20, dead volume |
| | | | calibration by means of He(99.996%), |
| | | | sample preparation 1 h at 23° C. + 16 h at |
| | | | 80° C. under vacuum, specific surface area |
| | | | based on devolatilized sample, evaluation |
| | | | by multi-point determination |
| Melting point 1st | 211 | ° C. | DIN 53765 DSC 7 from Perkin Elmer |
| heating procedure | | | heating./cooling rate 20 K/min |
| Recrystallization | 160 | ° C. | DIN 53765 DSC 7 from Perkin Elmer |
| temperature | | | heating./cooling rate 20 K/min |

| | |
|---|---|
| Conditioning of the | Material is stored for 24 h at 23° C. and 50% humidity before |
| material | processing/analysis |

TABLE 4
Characteristics of PA613 powder

| | Value | Unit | Test type/Test equipment/Test parameters |
|---|---|---|---|
| Polymer | PA613 | | |
| Bulk density | 0.450 | g/cm³ | DIN EN ISO 60 |
| Particle size d50 | 62 | μm | Malvern Mastersizer 2000, dry |
| | | | measurement, 20-40 g of powder added |
| | | | using Scirocco dry dispersion equipment. |
| | | | Feed rate vibratory trough 70%, dispersion |
| | | | air pressure 3 bar. Sample measurement |
| | | | time 5 seconds (5000 individual |
| | | | measurements), refractive index and blue- |
| | | | light value defined as 1.52. Evaluation via |
| | | | Mie theory |
| Particle size d10 | 46 | μm | Malvern Mastersizer 2000, for parameters |
| | | | see particle size d50 |
| Particle size d90 | 82 | μm | Malvern Mastersizer 2000, for parameters |
| | | | see particle size d50 |
| Mass fraction of | 1 | % | Malvern Mastersizer 2000, for parameters |
| particle size <10.48 μm | | | see particle size d50 |
| Pourability | 20 | s | DIN EN ISO 6186, method A, nozzle outlet |
| | | | diameter 15 mm |
| Solution viscosity | 1.65 | — | ISO 307, Schott AVS Pro, solvent sulphuric |
| | | | acid, volumetric method, duplicate |
| | | | determination, dissolution temperature |
| | | | 100° C., dissolution time 2 h, polymer |
| | | | concentration 5 g/l, measurement |
| | | | temperature 25° C. |
| BET (spec. surface | 9 | m²/g | ISO 9277, Micromeritics TriStar 3000, gas |
| area) | | | adsorption of nitrogen, discontinuous |
| | | | volumetric method, 7 measurement points |
| | | | at relative pressures P/P0 between about |
| | | | 0.05 and about 0.20, dead volume |
| | | | calibration by means of He(99.996%), |
| | | | sample preparation 1 h at 23° C. + 16 h at |
| | | | 80° C. under vacuum, specific surface area |
| | | | based on devolatilized sample, evaluation |
| | | | by multi-point determination |
| Melting point 1st | 209 | ° C. | DIN 53765 DSC 7 from Perkin Elmer |
| heating procedure | | | heating./cooling rate 20 K/min |
| Recrystallization | 168 | ° C. | DIN 53765 DSC 7 from Perkin Elmer |
| temperature | | | heating./cooling rate 20 K/min |

| | |
|---|---|
| Conditioning of the | Material is stored for 24 h at 23° C. and 50% humidity before |
| material | processing/analysis |

TABLE 5
Characteristics of PA613 powder

| | Value | Unit | Test type/Test equipment/Test parameters |
|---|---|---|---|
| Polymer | PA613 | | |
| Bulk density | 0.436 | g/cm³ | DIN EN ISO 60 |
| Particle size d50 | 61 | μm | Malvern Mastersizer 2000, dry |
| | | | measurement, 20-40 g of powder added |
| | | | using Scirocco dry dispersion equipment. |
| | | | Feed rate vibratory trough 70%, dispersion |
| | | | air pressure 3 bar. Sample measurement |
| | | | time 5 seconds (5000 individual |
| | | | measurements), refractive index and blue- |
| | | | light value defined as 1.52. Evaluation via |
| | | | Mie theory |
| Particle size d10 | 48 | μm | Malvern Mastersizer 2000, for parameters |
| | | | see particle size d50 |
| Particle size d90 | 82 | μm | Malvern Mastersizer 2000, for parameters |
| | | | see particle size d50 |
| Mass fraction of | 0 | % | Malvern Mastersizer 2000, for parameters |
| particle size <10.48 μm | | | see particle size d50 |
| Pourability | 26 | s | DIN EN ISO 6186, method A, nozzle outlet |
| | | | diameter 15 mm |
| Solution viscosity | 1.59 | — | ISO 307, Schott AVS Pro, solvent sulphuric |
| | | | acid, volumetric method, duplicate |
| | | | determination, dissolution temperature |
| | | | 100° C., dissolution time 2 h, polymer |
| | | | concentration 5 g/l, measurement |
| | | | temperature 25° C. |
| BET (spec. surface | 9.5 | m²/g | ISO 9277, Micromeritics TriStar 3000, gas |
| area) | | | adsorption of nitrogen, discontinuous |
| | | | volumetric method, 7 measurement points |
| | | | at relative pressures P/P0 between about |
| | | | 0.05 and about 0.20, dead volume |
| | | | calibration by means of He(99.996%), |
| | | | sample preparation 1 h at 23° C. + 16 h at |
| | | | 80° C. under vacuum, specific surface area |
| | | | based on devolatilized sample, evaluation |
| | | | by multi-point determination |
| Melting point 1st | 209 | ° C. | DIN 53765 DSC 7 from Perkin Elmer |
| heating procedure | | | heating./cooling rate 20 K/min |
| Recrystallization | 179 | ° C. | DIN 53765 DSC 7 from Perkin Elmer |
| temperature | | | heating./cooling rate 20 K/min |

| | |
|---|---|
| Conditioning of the | Material is stored for 24 h at 23° C. and 50% humidity before |
| material | processing/analysis |

TABLE 6

| | Polyamide | Modulus of | Tensile | Elongation |
|---|---|---|---|---|
| | from | elasticity | strength | at break |
| Example | Table | [Mpa] | [Mpa] | [%] |
| 1 (not according to the | 1 | 1746 | 46.3 | 19.5 |
| invention) | | | | |
| 2 (not according to the | 1 | 1793 | 46.8 | 17.2 |
| invention) | | | | |
| 3 (not according to the | 1 | 1679 | 45.6 | 16.8 |
| invention) | | | | |
| 4 (not according to the | 1 | 1796 | 46.7 | 18.1 |
| invention) | | | | |
| 5 (not according to the | 1 | 1807 | 46.1 | 16.7 |
| invention) | | | | |
| 6 (not according to the | 1 | 1672 | 45.2 | 17.4 |
| invention) | | | | |
| 7 (not according to the | 2 | 1023 | 38.2 | 41.0 |
| invention) | | | | |
| 8 (not according to the | 2 | 1240 | 42.6 | 34.1 |
| invention) | | | | |
| 9 (according to the | 3 | 2318 | 60.5 | 38.3 |
| invention) | | | | |
| 10 (according to the | 3 | 2347 | 61.3 | 35.4 |
| invention) | | | | |
| 11 (according to the | 3 | 2047 | 58.6 | 33.1 |
| invention) | | | | |
| 12 (according to the | 3 | 2298 | 60.9 | 34.2 |
| invention) | | | | |
| 13 (according to the | 4 | 2273 | 59.7 | 33.7 |
| invention) | | | | |
| 14 (according to the | 4 | 2251 | 58.7 | 33.1 |
| invention) | | | | |
| 15 (according to the | 4 | 2368 | 59.8 | 35.2 |
| invention) | | | | |
| 16 (according to the | 5 | 2287 | 60.3 | 32.6 |
| invention) | | | | |
| 17 (according to the | 5 | 2164 | 59.8 | 33.5 |
| invention) | | | | |

1. A process for layer-by-layer production of a three-dimensional object, the process comprising:
applying a layer of a powder material comprising polyamide PA613 onto a vertically moveable construction platform in a construction chamber to obtain a planar layer;
focusing a beam of electromagnetic radiation through a lens on a plane of the material layer;
traversing the focused beam across the plane of the material layer as directed by a control unit;
selectively melting the powder material under the focus of the beam according to the control unit to obtain a layer having a completed melt pattern;
lowering the vertically moveable construction platform; and
adding a layer of the powder material onto the layer having a completed melt pattern;
repeating the controlled melting; and
continuously adding a further layer of the powder material over the previous completed layer and repeating the controlled melting until the melt pattern of the three dimensional object is formed;
cooling the melt pattern to harden to the three dimensional shape; and
removing the three dimensional object from adhering powder material not melted by the focused beam.

2. The process according to claim 1, wherein a content of the polyamide PA613 in the powder material is at least 47 wt %, based on the total weight of the powder material.

3. The process according to claim 2 wherein the content of the polyamide PA613 is at least 75 wt %, based on the total weight of the powder material.

4. The process according to claim 1, wherein a number-average molecular weight of the polyamide PA613 is from 8000 to 50 000 g/mol.

5. The process according to claim 1, wherein a bulk density of the polyamide PA613 is from 0.35 to 0.55 g/cm³.

6. The process according to claim 1, wherein a d50 particle size of the polyamide PA613 is from 30 to 80 μm.

7. The process according to claim 1, wherein a pourability of the polyamide PA613 is not more than 70 s.

8. The process according to claim 1, wherein a solution viscosity of the polyamide PA613 is from 1.5 to 2.2.

9. The process according to claim 1, wherein a BET surface area of the polyamide PA613 is not more than 30 m²/g.

10. The process according to claim 1, wherein a melting point of the polyamide PA613 is from 205 to 215° C.

11. The process according to claim 1, wherein a processing temperature of the construction chamber is at least 190° C.

12. A three dimensional object obtained according to the process of claim 1.

13. The three dimensional object of claim 12, wherein a modulus of elasticity of the three dimensional object is greater than 2000 MPa.

14. The three dimensional object of claim 12, wherein an elongation at break of the three dimensional object is greater than 30%.

15. A layer-by-layer construction device for the process of claim 1, comprising:
a construction chamber having an adjustable-height construction platform;
an apparatus for applying a layer of the powder material comprising polyamide PA613 to the construction platform;
an irradiation device comprising a radiation source which emits electromagnetic radiation;
a control unit; and
a lens which is located in the beam path of the electromagnetic radiation.
